(19) United States
(12) Patent Application Publication
(10) Pub. No.: US 2022/0297212 A1
(43) Pub. Date: Sep. 22, 2022

(54) Laser Marking Tool for Saw Devices

(71) Applicant: Kerry Clark, Myrtle Point, OR (US)

(72) Inventor: Kerry Clark, Myrtle Point, OR (US)

(21) Appl. No.: 17/669,471

(22) Filed: Feb. 11, 2022

Related U.S. Application Data
(60) Provisional application No. 63/163,086, filed on Mar. 19, 2021.

(51) Int. Cl. B23D 59/00; B23D 57/02

(52) U.S. Cl. CPC B23D 59/001; B23D 57/023

(57) ABSTRACT

The measuring device described herein relates to an automatic wood marker attachment device. The device can be selectively attached to a chainsaw or power saw. More specifically, the device is clamped to the handlebar of a chainsaw or power saw using clamping arms. A pair of independently operating and articulating laser sources are used for projecting linear laser beams. The laser beams provide markings on a wood log to enable an operator to make accurate and precise cuts using the automatic laser markers. The laser sources are controlled using a control button to independently operate the laser sources. Further, the laser sources can be adjusted to any desired angle to allow automatic marking at any predeterminable direction and spacing.

### CROSS-REFERENCE TO RELATED APPLICATION

The present application claims priority to, and the benefit of, U.S. Provisional Application No. 63/163,086, which was filed on Mar. 19, 2021 and is incorporated herein by reference in its entirety.

### FIELD OF THE INVENTION

The present invention relates generally to wood marking devices. More specifically, the present invention relates to a laser marking tool for detachable and selective attachment to a chainsaw or power saw device. The laser marking tool can be clamped to the chainsaw or power saw device and comprises a clamping base for clamping to a handlebar of the saw device, a pair of independently operating and adjustable laser sources to project linear laser beams for marking on a wood allowing an operator to make accurate and precise cuts. The laser sources are controlled using a control button to independently operate the laser sources. Further, the laser source can be adjusted to any desired angle to allow automatic marking at any direction and position without the operator to bend in awkward positions. Accordingly, the present disclosure makes specific reference thereto. Nonetheless, it is to be appreciated that aspects of the present invention are also equally applicable to other like applications, devices, and methods of manufacture.

### BACKGROUND OF THE INVENTION

By way of background, operators need to make accurate and consistent cuts in wood and trees. Also, equal sizes of logs are used for commercial purposes and uses such as firewood for fuel. Traditionally, to ensure an accurate cut when utilizing a handheld saw device such as a chainsaw or a power saw, the operator would scribe a line on the surface of a workpiece and then use this line as a guide along which to cut. This manual process is extremely difficult and time-consuming. Also, woodcutters may not be able to fully mark each and every piece of wood they need to cut.

Also, the line or any other manual process such as tape marking is error prone as the line may not always be straight or in the desired direction. The lines may become faint and it also requires effort to mark the line or attach tape on hard wood. The operator may need to repeatedly put down the saw device to put the manual marking on the target wood.

Further, operators may find the wood that needs to be cut in awkward positions. An operator trying to mark wood in such awkward positions can lead to the cutter falling and suffering serious injury. Constant bending over to mark wood for cutting can lead to persistant aches and pains in the back.

Bucking is the process of cutting a felled and delimbed tree into logs. Significant value can be lost by sub-optimal bucking because logs destined for plywood, lumber and pulp each have their own value and specifications for length, diameter and defects. A felled and delimbed tree is cut into logs of standard sizes, a process called bucking. More specifically, cutting from the top down is overbucking, and cutting from the bottom up is underbucking. A logger who specializes in this job is a buck sawyer. Bucking may be done in a variety of ways, depending on the logging operation. Trees that have been previously felled and moved to a landing with a log skidder are spread out for processing. While many of the limbs have broken off during transport, the remaining limbs and stubs must be trimmed. The bucker will anchor the end of an auto-rewinding tape measure which is attached to his belt, and walk down the log trimming as he goes. The tape is anchored gently with a bent horseshoe nail in the bark, so it can be jerked loose when the measurement is completed. When a suitable place to buck the tree is located, the cut is made. Significant value may be lost by sub-optimal bucking. Local market conditions will determine the particular length of cut. It is common for log buyers to issue purchase orders for the length, diameter, grade and species that they will accept. There are often different prices for different items.

The pieces of bucked logs may be known by several names. Bolts are the pieces of a log which has been bucked into specific lengths which are less than 8 feet (2.4 m), especially short lengths. Billet is variously defined as a short piece of round or partially round wood (usually a smaller diameter than a block or bolt) or as a piece split or cut from a bolt, or sometimes synonymous with bolt, particularly when the pieces are intended as firewood, and sometimes means a piece of a billet after it has been split. Round is often associated with lengths of un-split firewood.

Therefore, there exists a long felt need in the art for an automatic marker generating device and method that automatically and accurately generates markers for spacing accurate cuts along a log or any other material. There is also a long felt need in the art for an automatic marker generating device and method that can be attached to the saw device. Additionally, there is a long felt need in the art for an automatic marker generating device and method that properly aligns the saw device with the marker indications. There is a long felt need in the art for an automatic marker generating device and method that eliminates constant bending over of the operator for marking the wood. Moreover, there is a long felt need in the art for an automatic marker generating device and method that can use a consistent mechanism for marking, which may not get faint and also does not leave a physical mark on the target wood. Finally, there is a long felt need in the art for an automatic marker generating device and method that provides a safer, more convenient, and more effective method of accurately cutting wood and firewood to a specific length.

The subject matter disclosed and claimed herein, in one embodiment thereof, comprises a laser marking device configured to removably attach to a saw device. More specifically, the laser marking device includes: a clamp mechanism to attach to a handlebar of the power saw device; a pair of adjustable and independent laser sources to project linear laser beams; and each laser source having laser diodes and a lens that can be adjusted at any desired angle. The laser beams act as automatic guiding markers allowing automatic marking during bucking, felling and limbing of wood. The integrated laser sources are adjustable to project the laser beams as per the requirements of an operator. The laser sources are controlled by a control button integrated to the device and allows independent operation of the laser sources.

In this manner, the novel laser alignment and marking device of the present invention accomplishes all of the forgoing objectives, and provides a relatively safe, easy and convenient solution to allow operators to automatically mark the wood to make accurate, precise and equal sized cuts. The device of the present invention is also user friendly, as it ensures that the operator does not need to bend over or spend time manually marking logs for cutting. Additionally, the device is attached to the saw device allowing easy operation and can simply be removed when not in use.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an attachable laser projecting device. The laser projecting device is configured to be selectively attached to a handlebar of a chainsaw or power saw. The laser projecting device further comprises: a clamping base having two hingedly attached clamp arms; the clamp arms having an upper clamp arm and a lower clamp arm wherein each arm is semi-circular shaped with a flat front projection; and, the upper clamp arm and the lower clamp arm are fastened to each other through a mechanical fastener and are pivotally movable with respect to each other through the hinge connection. A U-shaped movable handle connected to the upper clamp arm and the other end of the movable handle is connected to a lateral laser mount. The lateral laser mount includes two laser sources configured to project linear laser beams that act as guiding markers for an operator of the chainsaw or the power saw. The laser sources are adjustable and can be set to any desired angle and orientation to project the laser beams in desired direction.

In a further embodiment of the present invention, a laser marking device is configured to removably attach to a saw device. More specifically, the laser marking device includes: a clamp mechanism to attach to a handlebar of the power saw device; a pair of adjustable and independent laser sources to project linear laser beams; and each laser source having laser diodes and a lens that can be adjusted at any desired angle. The laser beams act as automatic guiding markers allowing automatic marking during bucking, felling, and limbing of wood. The integrated laser sources are adjustable to project the laser beams as per the requirements of an operator. The laser sources are controlled by a control button integrated to the device and allow independent operation of the laser sources.

In a further embodiment of the present invention, a chainsaw device with an attached laser marking device is disclosed. The chainsaw device includes a guide bar, a guide rail and a laser marking device removably attached to a handlebar of the chainsaw. The laser marking device includes a pair of adjustable independent laser sources for projecting linear laser beams or linear light lines outward from the chainsaw to form markings on the target wood or any other material to be cut using the chainsaw. The laser beams can be projected simultaneously by both the laser sources or any one laser source using an integrated control button.

In yet a further embodiment of the present invention, the laser marking device offers a way to measure, mark, and cut wood to equal sizes without constantly bending over or manually marking the wood. The device offers a safer, more convenient, and more effective method of cutting wood and fuel firewood to specific and consistent lengths. Further, the device eliminates any guesswork associated with cutting wood and eliminates the need to risk injury by manually marking wood.

In yet a further embodiment of the present invention, the laser alignment device has telescopic arms and handles for adjustment of the marking. As a result of the adjustability of the marking due to the telescopic arms and adjustability of the laser sources, it is possible to take a marking or bearing across certain distances and directions. When using the marking, for example, for cutting to length a tree trunk by means of a power saw or a chainsaw, the marking, as a result of the adjustability, can be used as a measuring device.

In yet a further embodiment of the present invention, a method of generating automatic markings for uniform and accurate cuts in a log or a tree is described. The method includes: clamping a linear laser beam generating device to the handlebar of a saw device; positioning a pair of laser sources integrated to the device in desired directions to project linear laser beams for generating marking for an operator the saw device; pushing a control button to turn on one or both laser sources to project laser beams; and, operating a guide bar and a guide rail to perform accurate cuts in a log with the laser beams functioning as automatic markers for the operator.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a laser alignment device of the present invention in accordance with the disclosed architecture;

FIG. 2 illustrates a rear perspective view of one potential embodiment of the laser alignment device of the present invention in accordance with the disclosed architecture;

FIG. 3 illustrates an enlarged perspective view showing the laser source of the laser alignment device of the present invention adjusted to a desired angle in accordance with the disclosed architecture;

FIG. 4 illustrates a perspective view showing how the laser alignment device of the present invention is clamped onto a handle of a chainsaw device in accordance with the disclosed architecture; and

FIG. 5 illustrates a perspective view showing an operator using a chainsaw with the attached laser mount device of the present invention for cutting a log of wood in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for an automatic marker generating device and method that automatically and accurately generates markers for spacing accurate cuts along a log or any other material. There is also a long felt need in the art for an automatic marker generating device and method that can be attached to the saw device. Additionally, there is a long felt need in the art for an automatic marker generating device and method that properly aligns the saw device with the marker indications. There is a long felt need in the art for an automatic marker generating device and method that eliminates constant bending over of the operator for marking the wood. Moreover, there is a long felt need in the art for an automatic marker generating device and method that can use a consistent mechanism for marking which may not get faint and also does not leave a physical mark on the target wood. Finally, there is a long felt need in the art for an automatic marker generating device and method that provides a safer, more convenient, and more effective method of cutting wood and firewood to specific lengths accurately.

The present invention, in one exemplary embodiment, is a novel laser projecting device. The laser projecting device is configured to detachably attach to handlebar of a chainsaw or power saw. The laser projecting device further comprises: a clamping base having two hingedly attached clamp arms; the clamp arms having an upper clamp arm and a lower clamp arm wherein each arm is semi-circular shaped with a flat front projection; and, the upper clamp arm and the lower clamp arm are fastened to each other through a mechanical fastener and are pivotally movable with respect to each other through the hinge connection. A movable handle connected to the upper clamp arm and the other end of the movable handle is connected to a lateral laser mount. The lateral laser mount includes two laser sources configured to project linear laser beams that act as guiding markers for an operator of the chainsaw or the power saw. The laser sources are adjustable and can be adjusted at any desired angle and orientation to project the laser beams in desired direction.

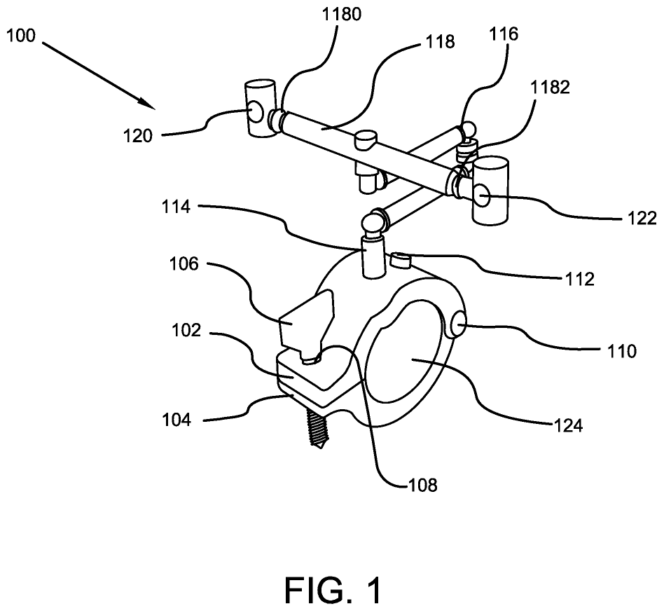

Referring initially to the drawings, FIG. 1 illustrates a perspective view of one potential embodiment of a laser alignment device of the present invention in accordance with the disclosed architecture. The laser alignment device 100 of the present invention is a small, portable device configured to attach to a chainsaw or a power saw for facilitating accurate and precise wood cutting and lumber sizing. The device 100 is designed to simplify tree felling and the cutting of logs to predeterminable lengths to maximize wood yield and/or conform to desired sizes. The device 100 is a valuable tool for forestry professionals, novice tree fellers and tree loggers for the cutting of logs to meet desired wood lengths for a lumber mill, or to meet desired wood lengths for a fireplace/furnace.

The alignment device 100 acts as a measuring tool and projects two lasers at desired angles that act as a ‘marker’ for indicating where to cut a wood log. The device 100 includes an upper clamp arm 102 and a lower clamp arm 104 to clamp the device 100 onto a portion of the chainsaw such as a handle. The clamp arms 102, 104 form an open area 124 allowing to clamp to a handle portion of the chainsaw or power saw. The upper clamp arm 102 and lower clamp arm 104 are connected to each other by a mechanical screw fastener 106 passing through symmetric holes 108. The screw 106 can be fastened to clamp the device onto a handle of a saw device. The upper clamp arm 102 and the lower clamp arm 104 are pivotally-connected along a hinge 110 allowing pivotal movement of the clamp arms 102, 104 during clamping and unclamping of the device 100.

A movable handle 116 is connected to a curved portion of upper clamp arm 102 through a connector 114. The movable handle 116 is connected to a lateral laser mount 118 that has laser sources 120, 122 connected at the extreme ends 1180, 1182 of the lateral laser mount 118. The laser sources 120, 122 project laser beam lights or linear light lines towards a target, such as a wood log, that act as markers for an operator of a chainsaw. The laser beams can be of any color as per the preferences of an operator. The beams are projected outward and help the operator to easily mark and target accurate wood cutting (i.e. log lengths). The laser sources 120, 122 are independent to each other and any one laser source can also be used based on the requirement of the user. The laser beams projected by the laser sources 120, 122 function as ‘markers’ for positioning the saw blade for cutting the wood.

A control button 112 is present on the device 100 to switch on and off the laser sources 120, 122. The device 100 can have an internal battery to provide power to the laser sources 120, 122. The control button 112 is connected to the laser sources 120, 122 through a wired circuit, thereby allowing the control button 112 to control the operation of the laser sources 120, 122. An LED indicator can be present to indicate the operation of the laser sources 120, 122 and can also indicate the power level of the built-in battery.

The extreme or distal ends 1180, 1182 of the lateral laser mount 118 can articulate to allow the laser sources 120, 122 to move and rotate in different orientations and alignments, thereby allowing the projection of the laser beams at various angles. The projected laser beams enable logs to be marked with a light beam and subsequently cut to the predetermined size without the use of manual tape measurements.

It should be noted that the shape and length of the movable handle 116 and the lateral laser mount 118 can be customized as per the preferences of the user. Both the movable handle 116 and the lateral laser mount 118 can be telescopic and can extend or retract both in longitudinal and lateral direction. It is to be appreciated that the movements and extensions of handle 116 and mount 118 enable a user to have a selectable height and reach of the laser sources 120, 122.

The laser device 100 is configured to be clamped to a portion of the chainsaw or power saw, but it should be appreciated that the device 100 can be clamped to any tubular or rectilinear surface which can fit within the open area 124 of the clamp arms 102, 104. The laser device 100 is easy to clamp and unclamp without requiring the use of tools. The laser device 100 is ideal for overbucking and underbucking of trees and wood logs. Additionally, the laser device 100 can be used for felling and limbing.

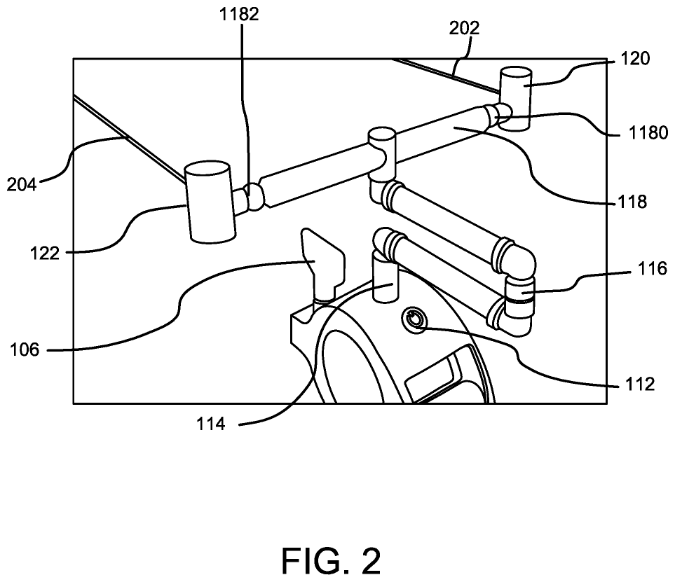

FIG. 2 illustrates a rear perspective view of one potential embodiment of the laser alignment device of the present invention in accordance with the disclosed architecture. The movable handle 116 connected to the connector 114 moves in lateral direction allowing the direction of the lateral laser mount 118 to change laterally and thus, change the direction of the laser sources 120, 122. Also, the extreme or distal ends of the lateral laser mount 118 provide articulation to change the angle of projection of the laser beams. As shown, laser beam 202 is projected by a first laser source 120 and the laser beam 204 is projected by a second laser source 122. The first laser source 120 can be tilted or fixed at a specific angle using the articulating distal end 1180. Similarly, the second laser source 122 can be tilted or fixed at a specific angle using the articulating distal end 1182.

For cutting wood placed at various angles, the laser sources 120, 122 are adjusted at a specific angle, thereby allowing the laser beams projected by the laser sources 120, 122 to function as markers for the operator. The laser beams 202, 204 act as both a felling direction indicator and a cutting guide. The laser beams 202, 204 projected in a desired direction are used for cutting short pieces of wood without complicated measuring or use of manual tape measures. The laser beams 202, 204 generate a linear marking i.e., a marking having the shape of a straight line on a target log of wood. The markings generated by the laser beams 202, 204 can be projected at a level where the chainsaw is placed against a tree trunk.

The handles 116, 118 are telescopic in nature and allow the device 100 to extend vertically. The distance or spacing between the two laser sources 120, 122 can be increased or decreased using the telescopic nature of the lateral laser mount 118. The telescopic mechanisms for extension, retraction and rotation of the handles 116, 118 can be of any conventional nature and thus is not described in detail.

It should be appreciated that the design and orientation of the movable handle 116 are such that they do not impede the movement of the clamp arms and the control button 112. An operator of a chainsaw or power saw can easily work with the chainsaw while the device 100 is clamped on the handle or any other portion of the chainsaw device.

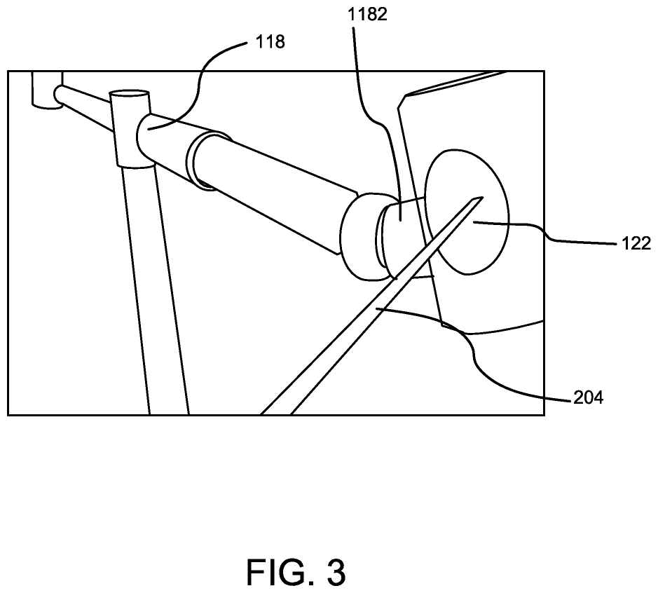

FIG. 3 illustrates a perspective view showing the laser source of the laser alignment device of the present invention adjusted to a desired angle in accordance with the disclosed architecture. Using the articulation and tiltable distal ends of the lateral laser mount 118, the laser sources can be adjusted to any desired angle. As shown in the present embodiment, the laser source 122 is adjusted using the articulating end 1182 to project laser beam 204 in a relatively downward direction.

The laser source 122 can be easily adjusted using minimal force to orient in a desired direction and at a desired angle. The same mechanism is applied to the other laser source 120. The laser sources 120, 122 are independent of each other and can be positioned and adjusted independently.

In one embodiment of the present invention, the laser sources 120, 122 are integrated with the laser device 100. Alternatively, the laser sources 120, 122 can be mounted and removed as per the preferences of an operator. The laser sources can be selectively unscrewed from the lateral laser mount 118 when not needed and can be mounted for use at the extreme ends of the lateral laser mount 118 when desired. The laser sources of the device 100 use laser diodes with an optional lens. The lens enables a straight-line projection of the laser beam from the laser sources 120, 122.

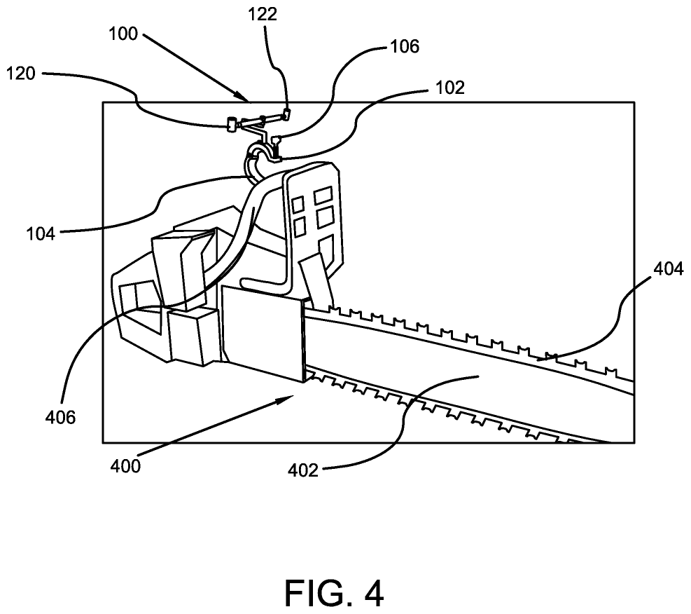

FIG. 4 illustrates a perspective view showing how the laser alignment device of the present invention is clamped onto a handle of a chainsaw device in accordance with the disclosed architecture. The clamping mechanism of the laser mount device 100 of the present invention allows the device 100 to be used with any conventional chainsaw 400. The device 100 is easily clamped onto the handlebar 406 of the saw device 400. Once the clamp arms 102, 104 of the device 100 are unscrewed, the device 100 is placed around the handlebar 406 of the chainsaw 400, such that the opening space of the clamp arms receives the handlebar 406 and the clamp arms 102, 104 are fastened around the handlebar 406 using the mechanical screw fastener 106. The device 100 clamps securely around the handlebar of the saw device and the lateral laser mount can then be oriented vertically above the handlebar of the chainsaw. Once the device 100 is securely clamped, the laser sources 120, 122 are turned on using the control button 112 (shown in FIG. 1) of the device and accordingly, the laser sources can be adjusted to project the laser beams in the desired position and direction.

As stated earlier, the arms of the device 100 are telescopic and adjustable. The arms have various connectors allowing the arms to move in both lateral and longitudinal direction. When the saw device is not used by an operator, the device 100 can be unclamped and stored at a secure location. The device 100 is easy to carry and is lightweight.

The device 100 does not impede the handling of the chainsaw 400, and the guide bar 402 and the guide chain 404 can be used easily with the laser sources on for laser beams to be used as markers. The device 100 has a geometry that is matched to the geometry of the handlebar of a chainsaw or power saw, such that the device 100 is securable in one position and does not move along the handlebar.

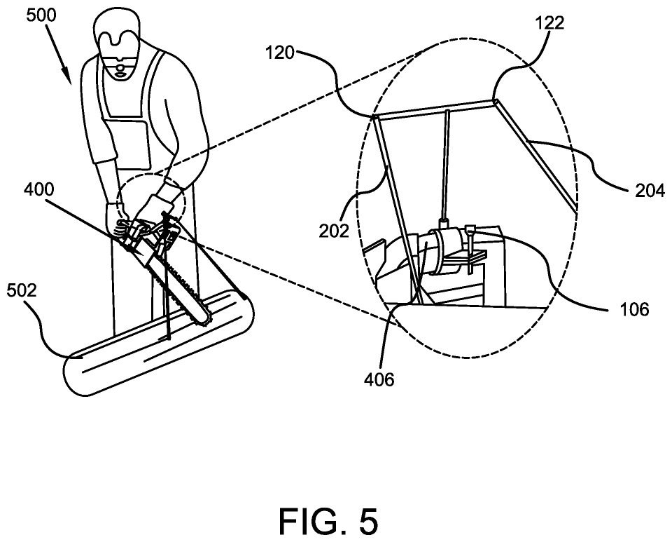

FIG. 5 illustrates a perspective view showing an operator using a chainsaw with the attached laser mount device of the present invention for cutting a log in accordance with the disclosed architecture. As shown, an operator 500 is using a chainsaw 400 with the attached laser mount device 100 of the present invention for cutting a log 502. The laser mount 100 is easily mounted around the handlebar 406, thereby allowing the operator 500 to easily handle the chainsaw device 400. The laser beams 202, 204 projected by the laser sources 120, 122 respectively function as guiding markers on the log of wood allowing the operator 500 to cut logs of uniform and predeterminable lengths. Accurate spacing of log cuts maximizes yield of the wood from a log.

Depending on the orientation of the log 502 and the operator 500, the orientation of the laser sources 120, 122 can be adjusted to project laser beams 202, 204 on the target. The device 100 offers a way to measure, space sequential cuts and cut wood to predeterminable lengths without constantly bending over or manually marking the log. It is to be appreciated that the predeterminable lengths, and spacing of cuts, can be described as a log, a buck, a bolt, a billet or a round. The accurate spacing of cuts enables a logger to maximize yield from a wood log.

The laser mount device 100 of the present invention provides a new lightweight and portable laser projecting device, which is capable of a low cost of manufacture with regard to both materials and labor, and which accordingly is then amenable to low prices of sale to the consuming public, thereby making such laser projecting device economically available to the buying public.

The laser mount device 100 is detachably or releasably connected to the handlebar of a saw device by means of clamping connection. In order to facilitate removal of the device 100, advantageously the clamp arms can be unfastened by loosening the mechanical screw.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “laser alignment device”, “laser mount device”, “laser device”, “alignment device”, “light device”, and “laser projecting device” are interchangeable and refer to the laser alignment device 100 of the present invention.

Notwithstanding the forgoing, the laser alignment device 100 of the present invention can be of any suitable size and configuration as is known in the art without affecting the overall concept of the invention, provided that it accomplishes the above-stated objectives. One of ordinary skill in the art will appreciate that the size, configuration, and material of the laser alignment device 100 as shown in the FIGS. are for illustrative purposes only, and that many other sizes and shapes of the laser alignment device 100 are well within the scope of the present disclosure. Although the dimensions of the laser alignment device 100 are important design parameters for user convenience, the laser alignment device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A laser marking device for marking a saw cut, the laser marking device comprising:
a pair of laser light sources;
a clamp for mounting said laser marking device on a saw;
an adjustable arm for adjusting a height and a reach of said pair of laser light sources;
said pair of laser light sources project laser beam lights onto a log;
said laser beam lights comprise at least one linear light line to act as a guiding marker for an alignment of said saw; and
said alignment of said saw corresponds to said saw cut.

2. The laser marking device of claim 1, wherein said pair of laser light sources project said laser beam lights simultaneously.

3. The laser marking device of claim 1, wherein said pair of laser light sources selectively project said laser beam lights independent of one another.

4. The laser marking device of claim 2, wherein said saw is a chainsaw.

5. The laser marking device of claim 4, wherein the marking of the saw cut includes a predeterminable length to maximize a yield from the log.

6. The laser marking device of claim 5, wherein said clamp is mounted to a handle of said saw.

7. The laser marking device of claim 6 further comprising a control button for selective operation of said pair of laser light sources.

8. A laser marking device for marking a plurality of saw cuts on a log, the laser marking device comprising:
a pair of laser light sources mounted to said laser marking device;
a clamp for mounting said laser marking device on a saw;
an adjustable arm for adjusting a height and a reach of said pair of laser light sources;
said adjustable arm articulates to adjust a position and an angle of said pair of laser light sources, wherein said pair of laser light sources project laser beam lights onto the log at a predeterminable spacing;
said laser beam lights include linear light lines to act as guiding markers for an alignment of said saw; and
said alignment of said saw corresponds to said plurality of saw cuts.

9. The laser marking device of claim 8, wherein said pair of laser light sources project said laser beam lights simultaneously.

10. The laser marking device of claim 8, wherein said pair of laser light sources selectively project said laser beam lights independent of one another.

11. The laser marking device of claim 9, wherein said saw is a chainsaw.

12. The laser marking device of claim 11, wherein said predeterminable spacing maximizes a yield from the log.

13. The laser marking device of claim 12, wherein said clamp is mounted to a handle of said saw.

14. The laser marking device of claim 13, further including a control button for selective operation of said pair of laser light sources.

15. A method for marking lengths of saw cuts on a log, the method comprising:
providing a pair of laser light sources mounted to a laser marking device;
clamping said laser marking device on a saw;
adjusting a height and a reach of said pair of laser light sources;
articulating a position and an angle of said pair of laser light sources;
projecting a pair of linear light lines from said pair of laser light sources onto the log at a predeterminable spacing; and
aligning said saw with said pair of linear light lines, wherein said saw, when aligned, corresponds to the saw cuts.

16. The method of claim 15, wherein said pair of laser light sources project said pair of linear light lines simultaneously.

17. The method of claim 15, wherein said pair of laser light sources selectively project said pair of linear light lines independent of one another.

18. The method of claim 15, wherein said saw is a chainsaw.

19. The method of claim 15, wherein said predeterminable spacing maximizes a yield from the log.

20. The method of claim 15, wherein said clamp is mounted to a handle of said saw.
